(19) United States
(12) Patent Application Publication
(10) Pub. No.: US 2013/0194611 A1
(43) Pub. Date: Aug. 1, 2013

(54) PRINTING SYSTEM, IMAGE FORMATION APPARATUS, AND METHOD FOR CONTROLLING IMAGE FORMATION APPARATUS

(71) Applicant: Yasushi YAMADE, Yokohama-shi (JP)

(72) Inventor: Yasushi YAMADE, Yokohama-shi (JP)

(21) Appl. No.: 13/749,994

(22) Filed: Jan. 25, 2013

(30) Foreign Application Priority Data
Jan. 26, 2012 (JP) 2012-014342

(51) Int. Cl. G06F 3/12

(52) U.S. Cl. CPC G06F 3/1221
USPC 358/1.14

(57) ABSTRACT

A power management apparatus determines whether or not a power usage amount is in a state in which printing by an image formation apparatus is to be prohibited, and transmits a printing prohibition command to the image formation apparatus based on a result of the determination so as to prohibit the printing. The image formation apparatus includes a job execution management unit configured to set a printing-prohibited state, in which the printing is prohibited in accordance with the printing prohibition command, and configured to suspend execution of a print job received by the receiving unit during the printing-prohibited state and a printing necessity inquiring unit configured to inquire a transmitting source of a print job, which is suspended by the job execution management unit from being executed, as to whether to perform printing thereof after cancellation of the printing-prohibited state.

This application is based on Japanese Patent Application No. 2012-014342 filed with the Japan Patent Office on Jan. 26, 2012, the entire content of which is hereby incorporated by reference.

### BACKGROUND OF THE INVENTION

1. Field of the Invention

The present invention relates to a printing system and an image formation apparatus, each of which performs printing while avoiding a peak time of power usage amount.

2. Description of the Related Art

In recent years, in order to avoid power failure resulting from excessive power usage in a wide range, it has been required to restrain peak power consumption of electric devices used in offices or the like.

As a method for avoiding printing during peak time of power usage, for example, Japanese Laid-Open Patent Publication No. 2008-167544 describes a method for determining whether or not an intended printing device can be activated, based on measured total power consumption of a plurality of printing devices and a total amount of power usable in all the printing devices.

In the method, when a user inputs a print job during a peak time of power usage amount, only a response is given to notify that the print job cannot be executed. Hence, in order to execute the print job, the user himself/herself has to input the print job while avoiding the peak time of power usage amount.

Japanese Laid-Open Patent Publication No. 2011-20267 describes a method for holding print jobs provided during a power saving mode, and executing the held print jobs collectively when the mode is reverted from the power saving mode to a normal power mode.

Japanese Laid-Open Patent Publication No. 2004-29892 discloses a method for performing a printing process of raster data when a printing executing request is issued from a PC (Personal Computer) after an image formation apparatus receives a print job transmitted from the PC, renders the print job to obtain the raster data, and allows the raster data to be referenced via a network with remote control from the PC.

### SUMMARY OF THE INVENTION

According to one embodiment, it is an object to provide a printing system and an image formation apparatus, each of which performs printing while avoiding a peak time of power usage amount and does not perform the printing if the printing is unnecessary for the user at the printing estimate time.

A printing system according to a certain aspect includes a power management apparatus configured to monitor a power usage amount in a predetermined management range, and an image formation apparatus disposed in the predetermined management range. The power management apparatus determines whether or not the power usage amount is in a state in which printing by the image formation apparatus is to be prohibited, and transmits a printing prohibition command to the image formation apparatus based on a result of the determination so as to prohibit the printing. The image formation apparatus includes: a receiving unit configured to receive a print job; a printing permission/prohibition command receiving unit configured to receive the printing prohibition command from the power management apparatus; a job execution management unit configured to set a printing-prohibited state, in which the printing is prohibited in accordance with the printing prohibition command from the power management apparatus, and configured to suspend execution of the print job received by the receiving unit during the printing-prohibited state; a printing necessity inquiring unit configured to inquire a transmitting source of the print job, which is suspended by the job execution management unit from being executed, as to whether to perform printing thereof after cancellation of the printing-prohibited state; and a job executing unit configured to execute at least one suspended print job after the cancellation of the printing-prohibited state, the at least one suspended print job having been confirmed through the printing necessity inquiring unit such that printing thereof is necessary.

Preferably, the power management apparatus measures the power usage amount in the predetermined management range, and transmits the printing prohibition command to the image formation apparatus based on a result of comparison between the power usage amount obtained through the measurement and a permissible power usage amount usable in the predetermined management range.

Particularly, the power management apparatus receives a change of setting regarding the permissible power usage amount.

Particularly, the power management apparatus obtains total usable power amount information, which indicates a total amount of power usable in the predetermined management range, and sets a value obtained by multiplying the amount of power indicated by the total usable power amount information by a usable ratio set by a user, as the permissible power usage amount.

Preferably, the image formation apparatus further includes a RIP unit configured to perform RIP (Raster Image Processing) onto the print job received during the printing-prohibited state and store resulting raster image data.

Particularly, when the execution of the suspended print job is determined as being unnecessary based on a result of the inquiry performed by the printing necessity inquiring unit, the job execution management unit deletes the raster image data associated with the print job.

Preferably, after the cancellation of the printing-prohibited state, the printing necessity inquiring unit inquires the transmitting source of the suspended print job as to whether to perform the printing.

Particularly, when the printing-prohibited state is canceled, the job execution management unit estimates printing completion estimate time at which printing of each of suspended print jobs is estimated to be completed, and the printing necessity inquiring unit provides a transmitting source of each of the suspended print jobs with an inquiry as to whether to perform the printing of the print job as well as a notification of the printing completion estimate time thus estimated.

Preferably, when the printing-prohibited state is canceled, the job execution management unit estimates printing completion estimate time at which printing of each of suspended print jobs is estimated to be completed, and the printing necessity inquiring unit provides a transmitting source of each of the suspended print jobs with a notification of the printing completion estimate time for the print job.

An image formation apparatus according to a certain aspect is disposed in a predetermined management range and provided to he capable of communicating with a power management apparatus configured to monitor a power usage amount in the predetermined management range. The image formation apparatus includes: a receiving unit configured to receive a print job; a printing permission/prohibition command receiving unit configured to receive a printing prohibition command from the power management apparatus, the printing prohibition command indicating that the power usage amount in the predetermined management range is in a state in which printing by the image formation apparatus is to be prohibited; a job execution management unit configured to set a printing-prohibited state, in which the printing is prohibited in accordance with the printing prohibition command from the power management apparatus, and configured to suspend execution of the print job received by the receiving unit during the printing-prohibited state; a printing necessity inquiring unit configured to inquire a transmitting source of a print job, which is suspended by the job execution management unit from being executed, as to whether to perform printing thereof after cancellation of the printing-prohibited state; and a job executing unit configured to execute at least one suspended print job after the cancellation of the printing-prohibited state, the at least one suspended print job having been confirmed through the printing necessity inquiring unit such that printing thereof is necessary.

Preferably, the image formation apparatus further includes a RIP unit configured to perform RIP (Raster Image Processing) onto the print job received during the printing-prohibited state and store resulting raster image data.

Particularly, when the execution of the suspended print job is determined as being unnecessary based on a result of the inquiry performed by the printing necessity inquiring unit, the job execution management unit deletes the raster image data associated with the print job.

Preferably, after the cancellation of the printing-prohibited state, the printing necessity inquiring unit inquires the transmitting source of the suspended print job as to whether to perform the printing.

Preferably, when the printing-prohibited state is canceled, the job execution management unit estimates printing completion estimate time at which printing of each of suspended print jobs is estimated to be completed, and the printing necessity inquiring unit provides a transmitting source of each of the suspended print jobs with a notification of the printing completion estimate time for the print job.

A method according to a certain aspect for controlling an image formation apparatus disposed in a predetermined management range and provided to be capable of communicating with a power management apparatus configured to monitor a power usage amount in the predetermined management range includes: receiving a print job; receiving a printing prohibition command from the power management apparatus, the printing prohibition command indicating that the power usage amount in the predetermined management range is in a state in which printing by the image formation apparatus is to be prohibited; setting a printing-prohibited state, in which the printing is prohibited in accordance with the printing prohibition command from the power management apparatus, and suspending execution of the print job received during the printing-prohibited state; inquiring a transmitting source of a print job, which is suspended from being executed, as to whether to perform printing thereof after cancellation of the printing-prohibited state; and executing at least one suspended print job after the cancellation of the printing-prohibited state, the at least one suspended print job having been confirmed such that printing thereof is necessary.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a general view showing a printing system.

FIG. 2 is a block diagram showing a schematic configuration of a PC terminal.

FIG. 3 is a block diagram showing a schematic configuration of a power management server.

FIG. 4 is a block diagram showing a schematic configuration of an image formation apparatus.

FIG. 5 is a front view showing the image formation apparatus.

FIG. 6 is a flowchart showing a flow of processes in the power management server.

FIG. 7 is a function block diagram of the image formation apparatus.

FIG. 8 is a flowchart showing a flow of processes in the image formation apparatus.

FIG. 9 is an illustrative diagram showing exemplary notification of completion estimate time of a print job.

### DESCRIPTION OF THE PREFERRED EMBODIMENTS

The following describes an embodiment with reference to figures.

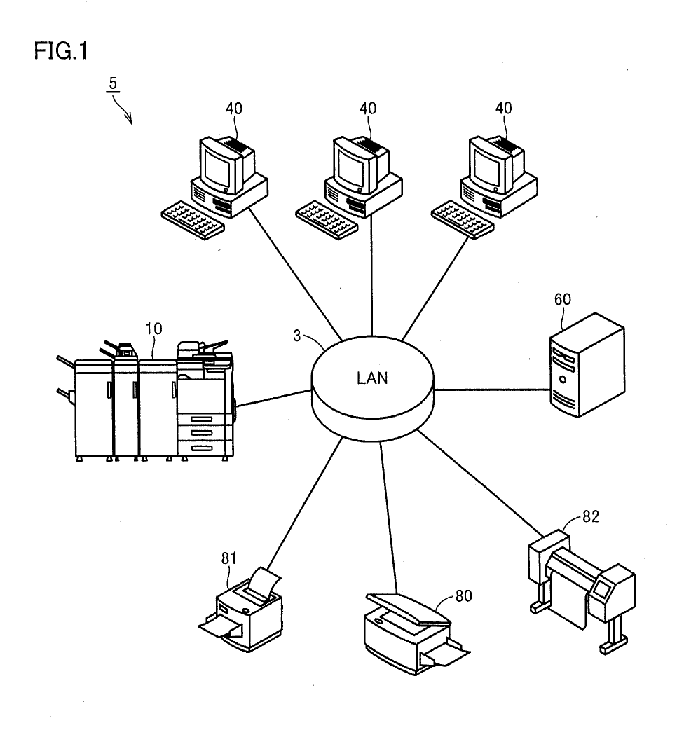

FIG. 1 shows a printing system 5 according to the present embodiment.

Referring to FIG. 1, as one example, printing system 5 is formed of an image formation apparatus 10, a plurality of PC (Personal Computer) terminals 40, a power management server 60, a copier 80, a printer 81, and a plotter 82, which are connected to one another via a LAN (Local Area Network).

Image formation apparatus 10 is a so-called “multi-functional peripheral”, which has functions of executing jobs such as a copy job for optically scanning a document and printing a duplicate image thereof on a recording sheet; a scan job for storing the image data of the scanned document in the form of a file or transmitting it to an external apparatus; and a print job for printing, on a recording sheet, an image associated with data transmitted from a PC terminal 40. In addition, image formation apparatus 10 is also capable of performing a post process, such as punching or stabling, onto a printed recording sheet in accordance with a content of a print job. The functions are exemplary, and image formation apparatus 10 may have other functions such as a function of FAX.

Each of copier 80, printer 81, and plotter 82 is a printing apparatus that performs printing based on a job.

Each of PC terminals 40 is operated by a user to transmit a print job to image formation apparatus 10, copier 80, printer 81, or plotter 82 constituting printing system 5.

From a predetermined information source (power usage amount publicly announced in a Web page of an electric power company, an intra-company information bulletin board, or the like), power management server 60 obtains information (hereinafter, also referred to as “total usable power amount information”) indicating a total amount of power that can be used in a whole of printing system 5, and determines a permissible power usage amount, which is a permissible value of the amount of power that can be used in the whole of printing system 5. Further, power management server 60 performs a function of measuring a power usage amount in each of the apparatuses constituting printing system 5, and controlling an operation of image formation apparatus 10 such that the total of the power usage amounts does not exceed the permissible power usage amount.

Specifically, when the power usage amount of the whole of printing system 5 is increased but does not exceed the permissible power usage amount of printing system 5 if image formation apparatus 10 executes a print job, power management server 60 transmits a command (hereinafter, also referred to as “printing permission command”) to image formation apparatus 10 so as to permit the printing. On the other hand, when the power usage amount of printing system 5 has already been more than the permissible power usage amount, or when the power usage amount of printing system 5 is increased to exceed the permissible power usage amount if image formation apparatus 10 executes a print job, power management server 60 transmits a command (hereinafter, also referred to as “printing prohibition command”) to image formation apparatus 10 so as to prohibit the printing.

The following describes a flow of basic processes in printing system 5 of the present invention. First, a user transmits a print job from a PC terminal 40 to image formation apparatus 10. Image formation apparatus 10 receives this print job, then performs RIP (Raster Image Processing) onto the received print job, and accumulates and stores raster image data resulting from the RIP. Then, image formation apparatus 10 checks whether or not power management server 60 has issued a printing permission command. When the printing permission command has been issued, image formation apparatus 10 starts printing immediately.

When the printing permission command has not been issued (i.e., a printing prohibition command has been issued), image formation apparatus 10 sets itself to a state (printing-prohibited state) in which printing is prohibited. Until the printing-prohibited state is canceled, i.e., until power management server 60 issues a printing permission command to cancel the printing prohibition command, image formation apparatus 10 suspends execution of the printing. When power management server 60 issues a printing permission command after the issuance of the printing prohibition command, image formation apparatus 10 provides the owner of the suspended print job (the user who has transmitted the print job) with a notification of time (completion estimate time) at which the print job is estimated to be completed, so as to inquire as to whether or not the output thereof is still necessary at the completion estimate time. When the user commands that the printing is still necessary, image formation apparatus 10 executes the print job in accordance with the command. When the user commands that the printing is unnecessary, image formation apparatus 10 deletes the print job and the raster image data in accordance with the command without executing the print job.

In this way, in accordance with the command from power management server 60, image formation apparatus 10 is controlled not to perform printing when the power usage amount exceeds the permissible power usage amount. Meanwhile, when the printing-prohibited state is canceled in accordance with the command from power management server 60 to change to the state in which the printing is permitted, image formation apparatus 10 provides the owner of the suspended print job with a notification of completion estimate time attained if the print job is executed immediately. In this way, it is confirmed whether or not the output of the printing is still necessary even at the time. Accordingly, unnecessary output can be restrained.

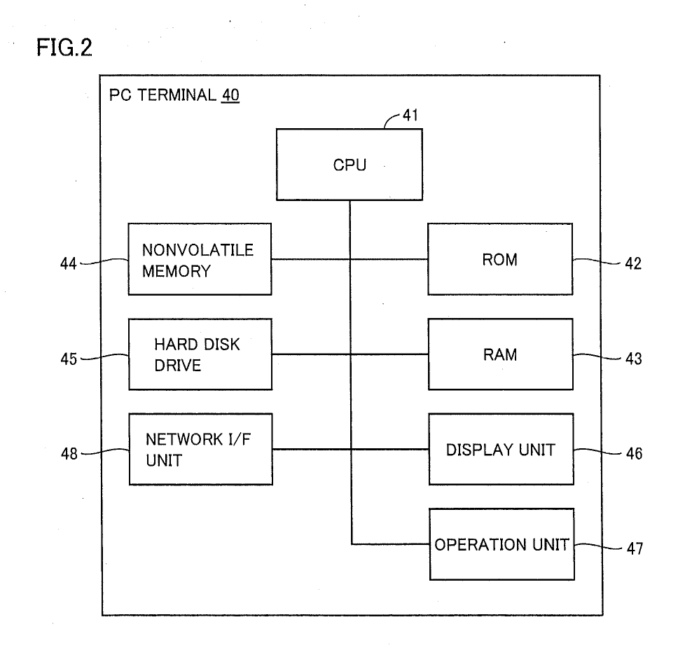

FIG. 2 shows a schematic configuration diagram of PC terminal 40.

Referring to FIG. 2, as one example, PC terminal 40 is configured to include: a CPU (Central Processing Unit) 41 for controlling an operation of PC terminal 40; a ROM (Read Only Memory) 42 connected to this CPU 41; a RAM (Random Access Memory) 43; a nonvolatile memory 44; a hard disk drive 45; a display unit 46; an operation unit 47; and a network I/F unit 48.

CPU 41 is based on an OS (Operating System) program stored in ROM 42 or hard disk drive 45, and executes middleware or application programs thereon. ROM 42 and the like store a various types of programs. CPU 41 performs a process in accordance with a program in ROM 42 or the like, thereby implementing each function of PC terminal 40 such as transmission of a job. RAM 43 is used as a work memory that temporarily stores various types of data when CPU 41 executes a program.

Nonvolatile memory 44 is a rewritable memory that can hold its storage even when the power is turned off (for example, a flash memory). Nonvolatile memory 44 stores information specific to the terminal, various types of setting information, and the like. Hard disk drive 45 is a nonvolatile storage device having a large capacity, and stores the OS program, various types of application programs, an information history associated with a job, and the like, for example.

Display unit 46 is formed of a liquid crystal display (LCD) or the like, and has a function of displaying details about various types of operations and settings. Operation unit 47 has a function of receiving various types of operations such as input of a job from a user, change of setting, and the like. Operation unit 47 is configured to include a keyboard, a mouse, and the like.

Network I/F unit 48 is an interface that makes communication with other external apparatuses connected via a network such as LAN 3. A job is transmitted via network I/F unit 48.

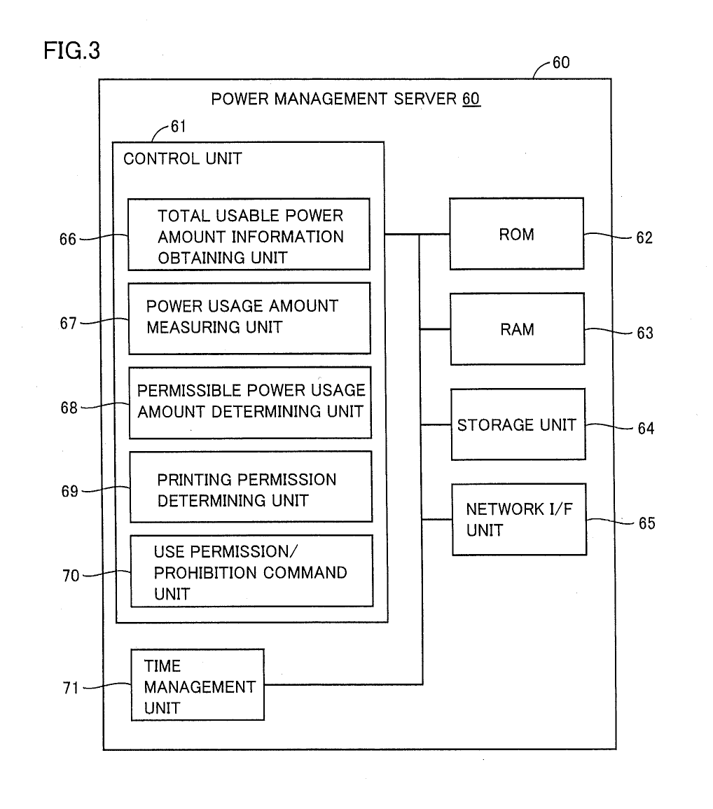

FIG. 3 shows a schematic configuration diagram of power management server 60.

Referring to FIG. 3, as one example, power management server 60 is configured to include a control unit 61, a ROM 62, a RAM 63, a storage unit 64, a network I/F unit 65, and a time management unit 71. Control unit 61 is mainly formed of a CPU (Central Processing Unit).

Control unit 61 of power management server 60 has functions as a total usable power amount information obtaining unit 66, a power usage amount measuring unit 67, a permissible power usage amount determining unit 68, a printing permission determining unit 69, and a use permission/prohibition command unit 70.

ROM 62 has various of types of programs stored therein. In accordance with these programs, control unit 61 performs processes to implement the respective functions of power management server 60. RAM 63 is used as a work memory that temporarily stores various types of data when control unit 61 executes a program.

Storage unit 64 is a nonvolatile storage device having a large capacity, and stores information about an amount of power consumed when performing each function of each apparatus of printing system 5, information specific to power management server 60, various types of setting information, obtained total usable power amount information, and the like.

Network I/F unit 18 is an interface that makes communication with other external apparatuses connected via a network such as LAN 3.

Total usable power amount information obtaining unit 66 obtains total usable power amount information from a predetermined information source. Examples of the information source include a Web page of an electric power company, an intra-company Web page, and the like. For example, total usable power amount information obtaining unit 66 obtains the total usable power amount information in accordance with a power usage amount publicly announced in a Web page of an electric power company, or a power usage amount announced in an intra-company Web page or an intra-company information bulletin board. The total usable power amount information does not need to be static and may be variable depending on a time period. It should be noted that the obtainment of the total usable power amount information may be performed in any manner as long as the total usable power amount information can be obtained. For example, total usable power amount information obtaining unit 66 can be configured to be directly supplied with the total usable power amount information from an electric power company or another management company. Alternatively, an administrator or the like may directly input the total usable power amount information using input means, whereby total usable power amount information obtaining unit 66 obtains the input value.

Power usage amount measuring unit 67 measures a power usage amount of each of the apparatuses constituting printing system 5. Specifically, as one example, power measuring instruments are provided to correspond to the apparatuses respectively. Power usage amount measuring unit 67 collects the measurement values obtained by the power measuring instruments, through the network. It is assumed that the measurement value corresponding to each apparatus and obtained by each power measuring instrument is stored in, for example, storage unit 64. Based on the measurement value of the power usage amount corresponding to the image formation apparatus and stored in storage unit 64, a below-described total amount (total power usage amount) of power estimated to be used if image formation apparatus 10 is operated can be calculated.

Permissible power usage amount determining unit 68 determines the permissible power usage amount of the whole of printing system 5 based on the total usable power amount information obtained by total usable power amount information obtaining unit 66. Specifically, as one example, the permissible power usage amount is assumed as a value obtained by multiplying, by a predetermined ratio (referred to as “usable ratio”), the power amount indicated by the total usable power amount information. The setting of the usable ratio can be changed by an administrator or the like. The usable ratio may be appropriately set depending on the printing system, for example, may be set at 80% or the like. Further, the value of the predetermined ratio may be adapted to be changed depending on a time period. In the present embodiment, there is illustrated a system in which the value obtained by multiplying the total usable power amount information by the predetermined ratio is determined as the permissible power usage amount, but the total usable power amount information can be used as the permissible power usage amount without any modification.

Printing permission determining unit 69 compares the total (referred to as “total power usage amount”) of power usage amounts of the apparatuses measured by power usage amount measuring unit 67, with the permissible power usage amount determined by permissible power usage amount determining unit 68. Based on the result of the comparison, printing permission determining unit 69 determines which one of the printing prohibition command and the printing permission command is to be issued to image formation apparatus 10.

Printing permission determining unit 69 determines to issue the printing prohibition command when image formation apparatus 10 is operating and the total power usage amount exceeds the permissible power usage amount on this occasion. When image formation apparatus 10 is operating and the total power usage amount does not exceed the permissible power usage amount, printing permission determining unit 69 determines to issue the printing permission command.

Meanwhile, printing permission determining unit 69 determines to issue the printing prohibition command when image formation apparatus 10 is not operating and the total of the total power usage amount and the amount of power estimated to be used if image formation apparatus 10 is operated exceeds the permissible power usage amount. When image formation apparatus 10 is not operating and the total of the total power usage amount and the amount of power estimated to he used if image formation apparatus 10 is operated does not exceed the permissible power usage amount, printing permission determining unit 69 determines to issue the printing permission command.

Based on the result of determination performed by printing permission determining unit 69, use permission/prohibition command unit 70 transmits the printing permission command or the printing prohibition command to image formation apparatus 10 via network I/F unit 65.

Time management unit 71 manages time information. Based on this time information, the obtainment of the total usable power amount information and the measurement of the power usage amount of each of the apparatuses constituting printing system 5 are respectively repeated in predetermined cycles. For example, the obtainment of the total usable power amount information is performed every 2 hours. The measurement of the power usage amount is performed every 10 minutes.

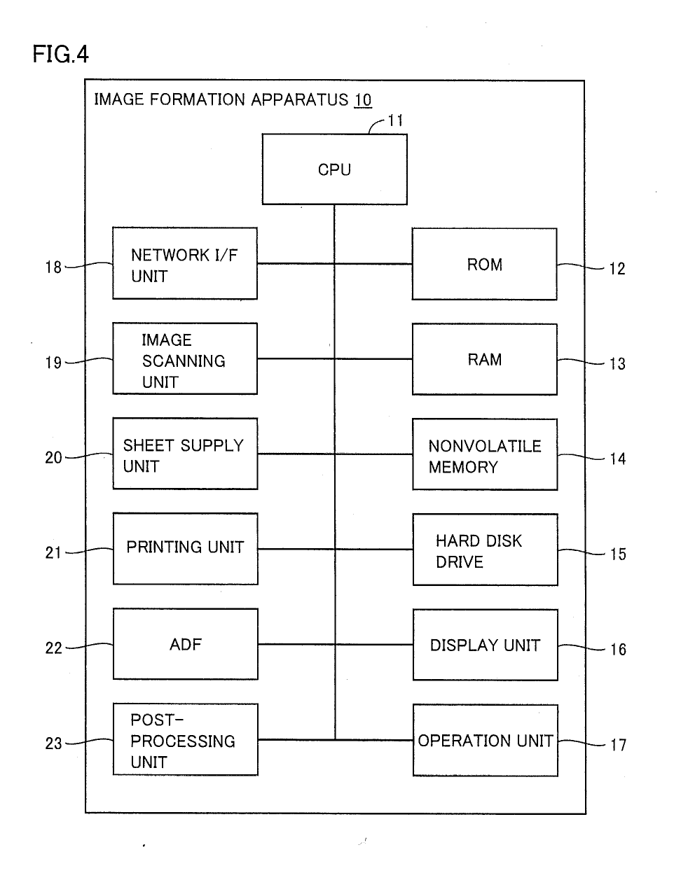

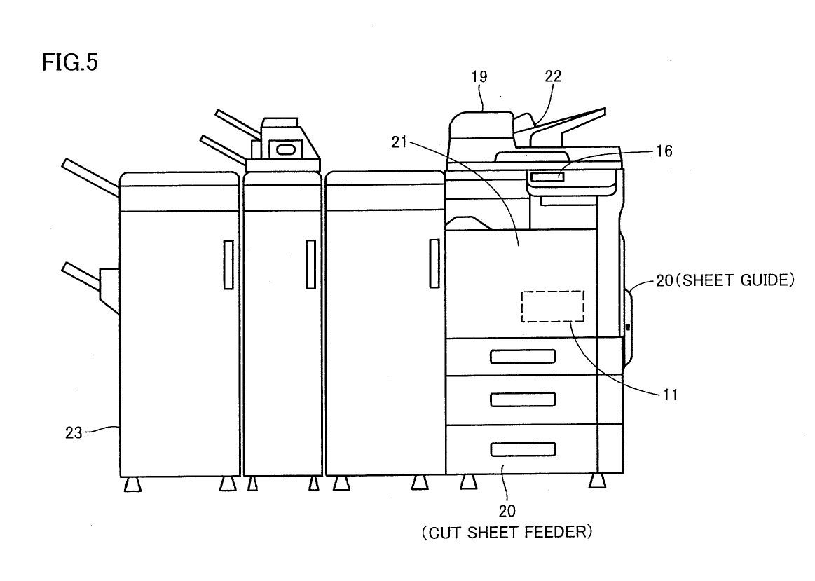

FIG. 4 shows a schematic configuration diagram of image formation apparatus 10. FIG. 5 shows a front view of the image formation apparatus.

Referring to FIG. 4, as one example, image formation apparatus 10 is configured to include: a CPU 11 for controlling an operation of image formation apparatus 10; a ROM 12 connected to this CPU 11; a RAM 13; a nonvolatile memory 14; a hard disk drive 15; a display unit 16; an operation unit 17; a network I/F unit 18; an image scanning unit 19; a sheet supply unit 20; a printing unit 21; an ADF (Auto Document Feeder) 22; and a post-processing unit 23.

CPU 11 is based on an OS program stored in ROM 12 or hard disk drive 15, and executes middleware or application programs thereon. ROM 12 stores various types of programs. CPU 11 performs processes in accordance with the programs in ROM 12, thereby implementing each function of image formation apparatus 10 such as execution of a job. RAM 13 is used as a work memory that temporarily stores various types of data when CPU 11 executes a program, an image memory that stores image data, or the like.

Nonvolatile memory 14 is a rewritable memory that can hold its storage even when the power is turned off (for example, a flash memory). Nonvolatile memory 14 stores information specific to the apparatus, various types of setting information, and the like. Hard disk drive 15 is a nonvolatile storage device having a large capacity, and stores the OS program, various types of application programs, print data, image data, an information history associated with a job, and the like, for example.

Display unit 16 is formed of a liquid crystal display or the like, and has a function of displaying details about various types of operations and settings. Operation unit 17 has a function of receiving various types of operations such as input of a job from the user, change of setting, and the like. Operation unit 17 is configured to include a touch panel that is provided on the screen of display unit 16 and that detects the coordinates of a location pressed thereon, as well as ten-keys, character input keys, a start key, and the like, which are external to the screen (see FIG. 4 and FIG. 5).

Network I/F unit 18 is an interface that makes communication with other external apparatuses connected via a network such as LAN 3.

Image scanning unit 19 has a function of obtaining image data by optically scanning a document. For example, image scanning unit 19 is configured to include: a light source for emitting light to a document set on a platen; a line image sensor for receiving reflected light thereof to scan the document by one line in the width direction; moving means for sequentially moving the scanning location in the longitudinal direction of the document based on a line as a unit; an optical path formed of lens, mirror, and the like to guide the reflected light from the document to the line image sensor so as to attain image formation; a converter for converting an analog image signal, which is output by the line image sensor, into digital image data; and the like (see FIG. 4 and FIG. 5).

Sheet supply unit 20 has an automatic sheet supplying function of automatically setting a sheet to a printing location when performing printing. Sheet supply unit 20 is formed of a cut sheet feeder that continuously supplies cut sheets (recording sheets) set on the sheet supply tray, a sheet guide for manually supplying the cut sheets (recording sheets) one by one, or the like (see FIG. 4 and FIG. 5).

Printing unit 21 has a function of forming an image on a recording sheet in accordance with image data. Here, printing unit 21 is configured as a so-called laser printer that performs image formation by means of an electrophotography process and that includes a transporting device for the recording sheet, a photoconductor drum, a charging device, a laser unit, a developing device, a transferring/separating device, a cleaning device, a fixing device, and the like. The image formation may be performed in accordance with an ink jet method or other methods (see FIG. 4 and FIG. 5).

ADF 22 has a function as an automatic document feeder for sequentially feeding a plurality of documents onto the platen when scanning images. In this way, for example, approximately 30 sheets of documents can be set at a time, thereby eliminating necessity of setting another document whenever a document is scanned (see FIG. 4 and FIG. 5).

Post-processing unit 23 performs a post process onto the recording sheet having the image formed thereon, such as stapling, punching, sheet folding, gluing and binding, or the like. A post process is performed based on a received print job (see FIG. 4 and FIG. 5).

The following describes flows of processes performed by power management server 60 and image formation apparatus 10.

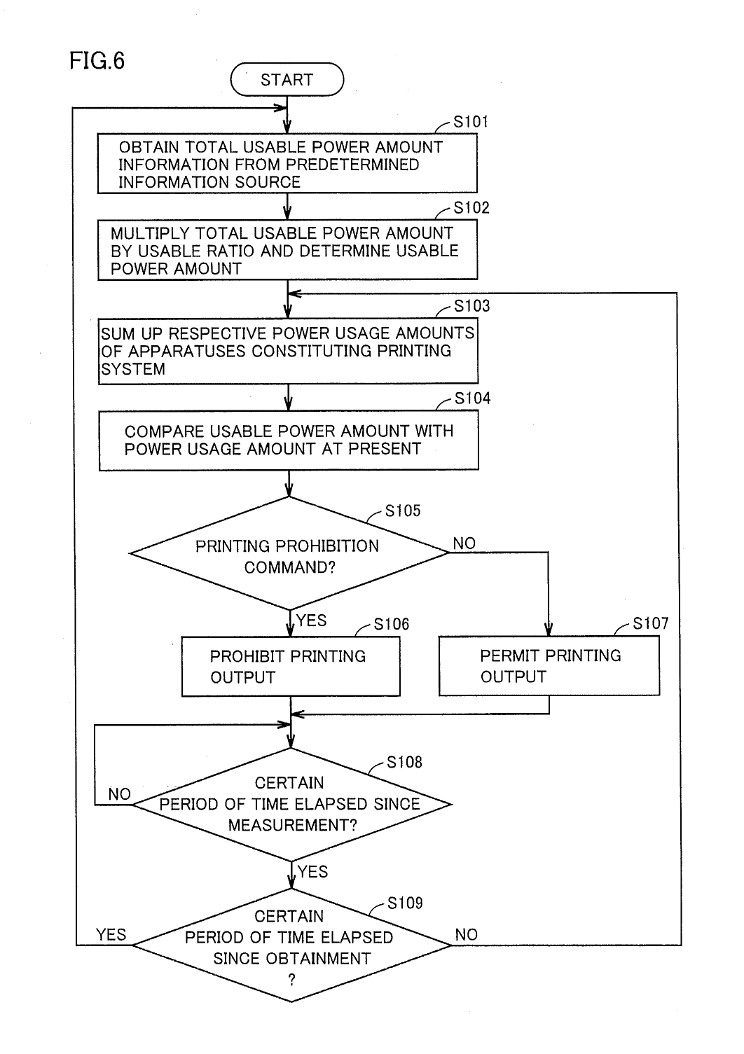

FIG. 6 shows a flow of processes performed by power management server 60.

Referring to FIG. 6, the processes are mainly performed by the functional blocks in control unit 61.

First, total usable power amount information obtaining unit 66 obtains total usable power amount information from a predetermined information source (step S101). Next, permissible power usage amount determining unit 68 determines, as a permissible power usage amount, a value obtained by multiplying the total usable power amount of the obtained total usable power amount information by a usable ratio (step S102).

Next, power usage amount measuring unit 67 measures and sums up respective power usage amounts of the apparatuses constituting printing system 5 (step S103).

Next, printing permission determining unit 69 compares the power usage amounts thus summed up (total power usage amount), with the permissible power usage amount (step S104), and determines which one of a printing prohibition command and a printing permission command is to be transmitted to image formation apparatus 10 (step S105). Specifically, when image formation apparatus 10 is operating, printing permission determining unit 69 checks whether or not the total power usage amount exceeds the permissible power usage amount. If the total power usage amount exceeds the permissible power usage amount, printing permission determining unit 69 determines to issue the printing prohibition command. If the total power usage amount does not exceed the permissible power usage amount, printing permission determining unit 69 determines to issue the printing permission command. On the other hand, when image formation apparatus 10 is not operating, printing permission determining unit 69 checks whether or not a total of the total power usage amount and an amount of power estimated to be used if image formation apparatus 10 is operated exceeds the permissible power usage amount. If it exceeds the permissible power usage amount, printing permission determining unit 69 determines to issue the printing prohibition command. If it does not exceed the permissible power usage amount, printing permission determining unit 69 determines to issue the printing permission command.

When printing permission determining unit 69 determines to issue the printing prohibition command (step S105; YES), use permission/prohibition command unit 70 transmits the printing prohibition command to image formation apparatus 10 via network I/F unit 65 (step S106). The process proceeds to step S108. When printing permission determining unit 69 determines to issue the printing permission command (step S105; NO), use permission/prohibition command unit 70 transmits the printing permission command to image formation apparatus 10 via network I/F unit 65 (step S107). The process proceeds to step S108.

Based on time information managed by time management unit 71, a certain period of time (for example, 10 minutes) is allowed to elapse from the measurement of the power usage amounts of the apparatuses constituting printing system 5 (step S108; NO). When the certain period of time has elapsed (step S108; YES), the process proceeds to step S109. Next, when a certain period of time (for example, 2 hours) has not elapsed since the obtainment of the total usable power amount information (step S109; NO), the process returns to step S103 and continues. On the other hand, when the certain period of time has elapsed (step S109; YES), the process returns to step S101 and continues. In power management server 60, the flow of these processes is looped and continued.

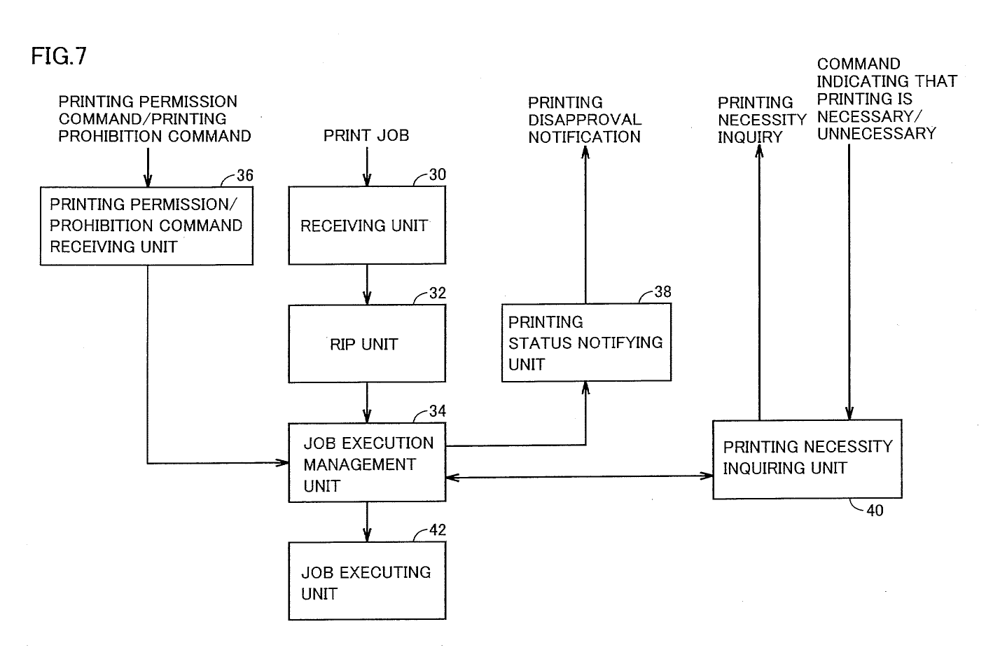

FIG. 7 is a function block diagram of image formation apparatus 10.

Referring to FIG. 7, image formation apparatus 10 implements each of functions such as execution of a job by CPU 11 performing a process in accordance with a program in ROM 12 or the like. Specifically, image formation apparatus 10 includes: a printing permission/prohibition command receiving unit 36 configured to receive the command indicating that printing is permitted or prohibited; a receiving unit 30 configured to receive a print job; a RIP unit 32 configured to perform RIP (Raster Image Processing); a job execution management unit 34 configured to manage execution of a print job; a printing status notifying unit 38 configured to notify a printing status; a printing necessity inquiring unit 40 configured to inquire as to whether or not the printing is necessary; and a job executing unit 42 configured to execute the print job.

Printing permission/prohibition command receiving unit 36 receives the printing permission command/printing prohibition command transmitted from power management server 60. Then, printing permission/prohibition command receiving unit 36 notifies job execution management unit 34 of the printing permission command/printing prohibition command thus received. Accordingly, job execution management unit 34 sets the printing-permitted state in accordance with the printing permission command. Meanwhile, job execution management unit 34 sets the printing-prohibited state in accordance with the printing prohibition command.

Receiving unit 30 receives a print job transmitted from PC terminal 40. Then, receiving unit 30 transmits the received print job to RIP unit 32.

RIP unit 32 interprets the command or PDL (Page Description Language), renders character and image data, and generates a bit map for outputting by a printer or an image setter, thus achieving conversion into raster image data. Then, RIP unit 32 accumulates and stores the raster image data in, for example, RAM 13.

Job execution management unit 34 manages execution of the print job having been through the RIP. Specifically, in the case of the printing-permitted state, job execution management unit 34 sends the converted raster image data to job executing unit 42. Job executing unit 42 sends the raster image data of the print job to printing unit 21 so as to print it.

On the other hand, in the case of the printing-prohibited state, job execution management unit 34 causes job executing unit 42 to accumulate and store the converted raster image data in hard disk drive 15. Further, job execution management unit 34 commands printing status notifying unit 38 to output a notification indicating that printing is disapproved.

In accordance with the command of job execution management unit 34, printing status notifying unit 38 provides the owner, who has transmitted the print job, with the notification (printing disapproval notification) indicating that the printing cannot be done (printing is disapproved). In this way, for example, the owner of the print job can readily recognize that it is currently under the printing prohibition command issued from power management server 60, i.e., recognize that it is in the peak time of power usage amount.

Further, after the printing prohibition command is canceled in accordance with the printing permission command after the printing-prohibited state, job execution management unit 34 checks whether or not there is a currently suspended print job. When job execution management unit 34 determines that there is a currently suspended print job, job execution management unit 34 commands printing necessity inquiring unit 40 to inquire the transmitting source of the print job as to whether or not the printing is necessary. In doing so, job execution management unit 34 calculates completion estimate time for the currently suspended print job as described later. Then, job execution management unit 34 notifies printing necessity inquiring unit 40 of the calculated completion estimate time for the print job.

In accordance with the command from job execution management unit 34, printing necessity inquiring unit 40 inquires the transmitting source of the print job as to whether or not the printing is necessary. Specifically, printing necessity inquiring unit 40 provides a printing necessity inquiry to the owner who has transmitted the print job. The printing necessity inquiry includes information regarding the completion estimate time for the print job. From the owner, printing necessity inquiring unit 40 receives a command indicating that the printing is necessary/unnecessary, and notifies job execution management unit 34 of it.

When job execution management unit 34 receives the owner's command indicating that the printing is necessary, job execution management unit 34 commands job executing unit 42 to start execution of the currently suspended print job. Job executing unit 42 sends raster image data of the print job to printing unit 21 so as to print it. On the other hand, when job execution management unit 34 receives the owner's command indicating that the printing is unnecessary, job execution management unit 34 deletes the print job (raster image data) having been through the RIP and accumulated and stored in RAM 13. In this way, the print job unnecessary for the owner can be deleted, thereby securing a storage area in hard disk drive 15.

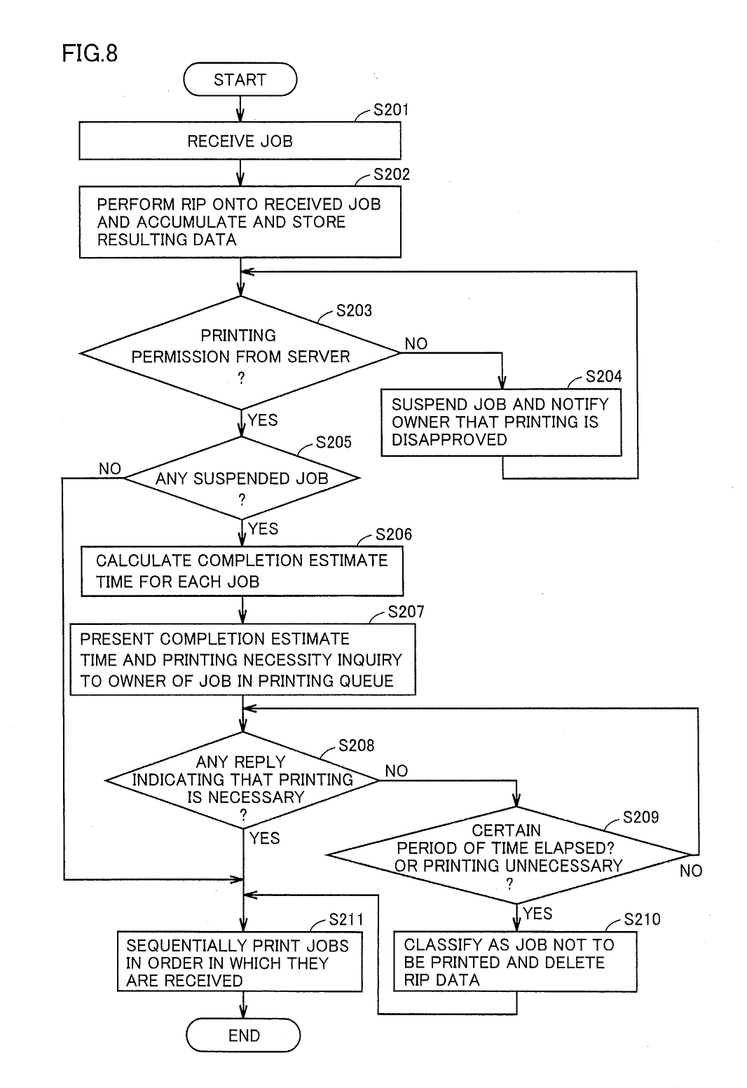

FIG. 8 shows a flow of processes performed by image formation apparatus 10. The processes are performed by the functional blocks with CPU 11 mainly cooperating with respective units.

Referring to FIG. 8, receiving unit 30 of image formation apparatus 10 receives a print job via network I/F unit 18 (step S201).

Then, RIP unit 32 performs RIP onto the received print job, and accumulates and stores the raster image data resulting from the RIP (step S202). In doing so, the print job (job execution condition) is also stored in, for example, RAM 13.

Next, job execution management unit 34 determines whether or not power management server 60 has issued a printing permission (step S203). Specifically, printing permission/prohibition command receiving unit 36 receives the printing permission command/printing prohibition command from power management server 60 via network I/F unit 18, and notifies job execution management unit 34 of the received printing permission command/printing prohibition command. Job execution management unit 34 determines whether or not the printing permission command/printing prohibition command has been received from printing permission/prohibition command receiving unit 36. Job execution management unit 34 sets the printing-permitted state in accordance with the printing permission command. Job execution management unit 34 sets the printing-prohibited state in accordance with the printing prohibition command.

In the case where job execution management unit 34 has determined that the most recent command received from power management server 60 is not a printing permission command on this occasion (step S203; NO), i.e., in the case where the last command is a printing prohibition command, the received print job is suspended and the transmitting source of the print job (owner of the print job) is notified that the printing is currently disapproved (step S204). Specifically, job execution management unit 34 commands printing status notifying unit 38 to notify that the printing is disapproved. Then, the process returns to step S203 and continues.

In the case where a new print job is received during the loop of steps S203 and S204, RIP unit 32 also performs the RIP onto this print job and accumulates and stores resulting raster image data.

On the other hand, when job execution management unit 34 determines that the most recent command received from power management server 60 is a printing permission command (step S203; YES), the process proceeds to step S205.

In step S205, job execution management unit 34 determines whether or not there is a currently suspended print job. When job execution management unit 34 determines that there is a currently suspended print job (step S205; YES), the process proceeds to step S206. On the other hand, when job execution management unit 34 determines that there is no currently suspended print job (step S205; NO), the process proceeds to step S211.

In step S206, job execution management unit 34 calculates a completion estimate time for the stored print job (step S206). Specifically, it is assumed that hard disk drive 15 has a previously registered estimate (estimate time) of time required to process each sheet in the case where the print job is only for printing, the case where the printing job is for both printing and post processing, or other cases. Then, job execution management unit 34 multiplies the estimate time registered in hard disk drive 15 by the number of sheets to be printed, and determines the time, which is obtained by the multiplication, as time (referred to as “printing-required time”) required to execute the print job. Thereafter, completion estimate time for the print job is calculated.

In the case where a plurality of print jobs are suspended, job execution management unit 34 calculates printing-required time for each of the print jobs, and calculates completion estimate time for each print job, assuming that the print jobs are to be executed in an order in which the jobs are received. Regarding the print job to be executed first, time obtained by adding the printing-required time to the current time is estimated as completion estimate time for the print job. Regarding the print job to be executed second, completion estimate time is calculated assuming that the completion estimate time of the print job to be executed first is the estimated execution starting time of the print job to be executed second. Regarding the print job to be executed third, completion estimate time is calculated assuming that the completion estimate time of the print job to be executed second is the estimated execution starting time of the print job to be executed third. Regarding each of the print jobs to be executed fourth and later, completion estimate time is calculated in a similar manner.

Job execution management unit 34 commands printing necessity inquiring unit 40 to provide the owner of the print job with the notification (printing necessity inquiry) for inquiring whether or not the printing is necessary as well as the completion estimate time calculated in step S206 with regard to the print job, through network I/F unit 18 (step S207). Here, for each print job, printing necessity inquiring unit 40 provides the owner, who has transmitted the print job, with the notification of the completion estimate time of the print job. The owner who has transmitted the print job checks the completion estimate time of the print job in PC terminal 40 having transmitted the print job, confirms that the execution of the print job is necessary or unnecessary even at the completion estimate time in accordance with the printing necessity inquiry, and replies to image formation apparatus 10.

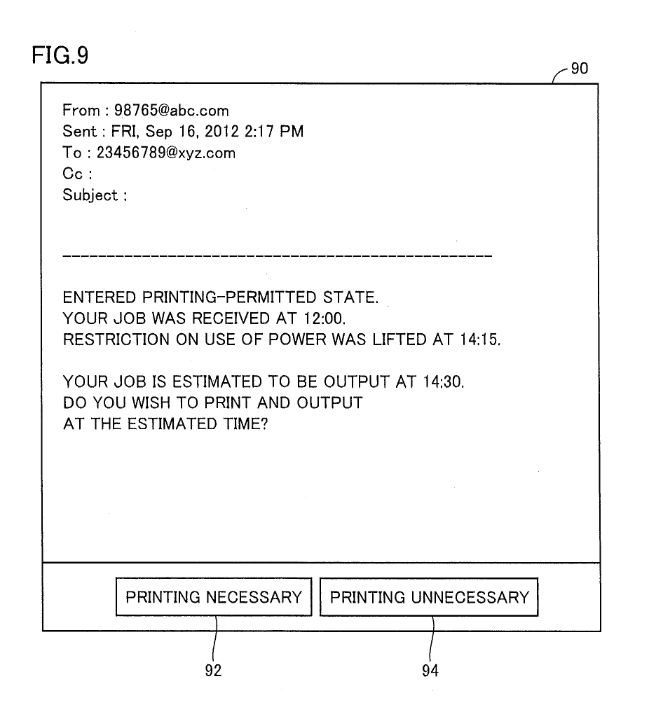

FIG. 9 shows a printing necessity inquiry screen 90, which is one exemplary printing necessity inquiry displayed on display unit 46 of PC terminal 40.

Referring to FIG. 9, the user checks the completion estimate time of the print job on this screen.

In the present embodiment, as one example, not only the completion estimate time of the print job but also the time of receipt of the job and time of lifting the restriction on use of power can be checked. It should be noted that such information is exemplary, and other information can be also included in printing necessity inquiry screen 90.

Printing necessity inquiry screen 90 is provided with a “printing necessary” button 92 and a “printing unnecessary” button 94 so as to allow for selection of necessity/unnecessity of the printing through operation unit 47.

When the user selects “printing necessary” button 92 through operation unit 47, a command is transmitted (replied) to image formation apparatus 10 via network I/F unit 48 so as to indicate that execution of the print job is necessary.

On the other hand, when the user selects “printing unnecessary” button 94 through operation unit 47, a command is transmitted (replied) to image formation apparatus 10 via network I/F unit 48 so as to indicate that execution of the print job is unnecessary.

As described above, printing necessity inquiring unit 40 receives the transmission (reply).

After the transmission of the printing necessity inquiry, image formation apparatus 10 executes the print job based on the reply of PC terminal 40 to the printing necessity inquiry.

Referring to FIG. 8 again, job execution management unit 34 of image formation apparatus 10 determines whether or not the printing is necessary (step S208).

When no reply (response) indicating that the printing is necessary is received via printing necessity inquiring unit 40 (step S208; NO), job execution management unit 34 proceeds the process to step S209. When no reply indicating that the printing is necessary or unnecessary is received via printing necessity inquiring unit 40 and a certain period of time has not elapsed (step S209; NO), job execution management unit 34 returns the process to step S208 and continues the process.

When the certain period of time has elapsed since the transmission of the printing necessity inquiry via printing necessity inquiring unit 40 or when there is a reply indicating that the printing is unnecessary (step S209; YES), job execution management unit 34 classifies this print job as a job not to be printed, and deletes the raster image data corresponding to the print job (step S210). The certain period of time may be set appropriately by the user to such an extent that the completion estimate time of the print job is less affected. Examples thereof include 3 minutes, 5 minutes, and the like.

When there is a reply indicating that the printing is necessary (step S208; YES), job execution management unit 34 proceeds the process to step S211. In step S211, job executing unit 42 sequentially prints print jobs not classified as jobs not to be printed, in an order in which they are received, and ends the process.

According to the present embodiment, power management server 60 sets a permissible power usage amount as a permissible value for power usable in the whole of printing system 5, measures a power usage amount of power currently used in each of the apparatuses, compares a total (total power usage amount) of the power usage amounts obtained through the measurement with the permissible power usage amount, and determines whether to issue the printing prohibition command or the printing permission command. When image formation apparatus 10 is operating, power management server 60 checks whether or not the total power usage amount exceeds the permissible power usage amount. If the total power usage amount exceeds the permissible power usage amount, the printing prohibition command is issued. If the total power usage amount does not exceed the permissible power usage amount, the printing permission command is issued. Meanwhile, when image formation apparatus 10 is not operating, power management server 60 checks whether or not the total (total power usage amount) of the total of the power usage amounts obtained through the measurement and the power estimated to be used if image formation apparatus 10 is operated exceeds the permissible power usage amount. If it exceeds the permissible power usage amount, the printing prohibition command is issued. If it does not exceed the permissible power usage amount, the printing permission command is issued.

Further, when a print job is received during the printing-prohibited state (in the case where the most recent command is a printing prohibition command), image formation apparatus 10 transmits the printing necessity inquiry to the transmitting source of the print job based on the print job after the printing is permitted. Image formation apparatus 10 serves to perform printing when a reply to the printing necessity inquiry is received to indicate that the printing is necessary, and serves not to perform printing when a reply is received to indicate that the printing is unnecessary or no reply is received. In this way, when performing printing, printing system 5 can avoid peak time of power usage amount and can restrain printing unnecessary for the user.

In the present embodiment, the printing necessity inquiry is performed in the case where a print job is received while printing is prohibited and thereafter printing permission is issued. However, the printing necessity inquiry may be transmitted to the owner of the print job immediately after the receipt of the print job. If a reply is provided at the time to indicate that the printing is unnecessary, raster image data corresponding to the print job is deleted. If a reply is provided at the time to indicate that the printing is necessary or if no reply is provided, the printing necessity inquiry may be transmitted once again to the owner of the print job after the printing is permitted.

In addition, in the present embodiment, printing is not performed when no reply to the printing necessity inquiry is provided, but printing may be performed when there is no reply.

Further, in the present embodiment, the printing necessity inquiry is performed in the case where a print job is received while printing is prohibited and thereafter the printing permission is issued. However, in the case where a new print job is received when processing of a currently executed print job takes time and there are accordingly a plurality of incomplete print jobs even in a state in which the printing is permitted, the necessity/unnecessity of the printing of the newly received print job may be inquired by transmitting a completion estimate time and a printing necessity inquiry to the owner of the print job.

Examples of the apparatuses using electric power and included in printing system 5 include not only the apparatuses illustrated above, but also any apparatuses using electric power such as illuminations, air conditioners, and floor heaters unless they are driven using a battery.

In the present embodiment, one image formation apparatus 10 is included in printing system 5, but a plurality of image formation apparatuses 10 may be included therein. Image formation apparatus 10 may be a small apparatus or a large apparatus.

In the present embodiment, power management server 60 and image formation apparatus 10 are operated independently, but power management server 60 may be incorporated in image formation apparatus 10 to be operated as a single apparatus.

The predetermined information source is not limited to the one illustrated in the present embodiment. Further, the information to be obtained is not limited to only the total usable power amount information, and other information may be also simultaneously obtained. For example, apart from the total usable power amount information, power usage information in a region other than the region in which printing system 5 is disposed, power usage information in the past, and the like may be obtained. With reference to these information, the permissible power usage amount may be determined.

Although the present invention has been described and illustrated in detail, it is clearly understood that the same is by way of illustration and example only and is not to be taken by way of limitation, the scope of the present invention being interpreted by the terms of the appended claims.

What is claimed is:

1. A printing system comprising a power management apparatus configured to monitor a power usage amount in a predetermined management range, and an image formation apparatus disposed in said predetermined management range, said power management apparatus determining whether or not said power usage amount is in a state in which printing by said image formation apparatus is to be prohibited, said power management apparatus transmitting a printing prohibition command to said image formation apparatus based on a result of the determination so as to prohibit the printing,
said image formation apparatus including:
a receiving unit configured to receive a print job;
a printing permission/prohibition command receiving unit configured to receive said printing prohibition command from said power management apparatus;
a job execution management unit configured to set a printing-prohibited state, in which the printing is prohibited in accordance with said printing prohibition command from said power management apparatus, and configured to suspend execution of the print job received by said receiving unit during said printing-prohibited state;
a printing necessity inquiring unit configured to inquire a transmitting source of the print job, which is suspended by said job execution management unit from being executed, as to whether to perform printing thereof after cancellation of said printing-prohibited state; and
a job executing unit configured to execute at least one suspended print job after the cancellation of said printing-prohibited state, said at least one suspended print job having been confirmed through said printing necessity inquiring unit such that printing thereof is necessary.

2. The printing system according to claim 1, wherein said power management apparatus measures the power usage amount in said predetermined management range, and transmits said printing prohibition command to said image formation apparatus based on a result of comparison between the power usage amount obtained through the measurement and a permissible power usage amount usable in said predetermined management range.

3. The printing system according to claim 2, wherein said power management apparatus receives a change of setting regarding said permissible power usage amount.

4. The printing system according to claim 2, wherein said power management apparatus obtains total usable power amount information, which indicates a total amount of power usable in said predetermined management range, and sets a value obtained by multiplying the amount of power indicated by said total usable power amount information by a usable ratio set by a user, as said permissible power usage amount.

5. The printing system according to claim 1, wherein said image formation apparatus further includes a RIP unit configured to perform RIP (Raster Image Processing) onto the print job received during said printing-prohibited state and store resulting raster image data.

6. The printing system according to claim 5, wherein when the execution of the suspended print job is determined as being unnecessary based on a result of the inquiry performed by said printing necessity inquiring unit, said job execution management unit deletes the raster image data associated with the print job.

7. The printing system according to claim 1, wherein after the cancellation of said printing-prohibited state, said printing necessity inquiring unit inquires the transmitting source of said suspended print job as to whether to perform said printing.

8. The printing system according to claim 7, wherein
when said printing-prohibited state is canceled, said job execution management unit estimates printing completion estimate time at which printing of each of suspended print jobs is estimated to be completed, and
said printing necessity inquiring unit provides a transmitting source of each of the suspended print jobs with an inquiry as to whether to perform said printing of the print job as well as a notification of the printing completion estimate time thus estimated.

9. The printing system according to claim 1, wherein
when said printing-prohibited state is canceled, said job execution management unit estimates printing completion estimate time at which printing of each of suspended print jobs is estimated to be completed, and
said printing necessity inquiring unit provides a transmitting source of each of the suspended print jobs with a notification of the printing completion estimate time for the print job.

10. An image formation apparatus disposed in a predetermined management range and provided to be capable of communicating with a power management apparatus configured to monitor a power usage amount in said predetermined management range, comprising:
a receiving unit configured to receive a print job;
a printing permission/prohibition command receiving unit configured to receive a printing prohibition command from said power management apparatus, said printing prohibition command indicating that the power usage amount in said predetermined management range is in a state in which printing by said image formation apparatus is to be prohibited;
a job execution management unit configured to set a printing-prohibited state, in which the printing is prohibited in accordance with said printing prohibition command from said power management apparatus, and configured to suspend execution of the print job received by said receiving unit during said printing-prohibited state;
a printing necessity inquiring unit configured to inquire a transmitting source of the print job, which is suspended by said job execution management unit from being executed, as to whether to perform printing thereof after cancellation of said printing-prohibited state; and
a job executing unit configured to execute at least one suspended print job after the cancellation of said printing-prohibited state, said at least one suspended print job having been confirmed through said printing necessity inquiring unit such that printing thereof is necessary.

11. The image formation apparatus according to claim 10, further comprising a RIP unit configured to perform RIP (Raster Image Processing) onto the print job received during said printing-prohibited state and store resulting raster image data.

12. The image formation apparatus according to claim 11, wherein when the execution of the suspended print job is determined as being unnecessary based on a result of the inquiry performed by said printing necessity inquiring unit, said job execution management unit deletes the raster image data associated with the print job.

13. The image formation apparatus according to claim 10, wherein after the cancellation of said printing-prohibited state, said printing necessity inquiring unit inquires the transmitting source of said suspended print job as to whether to perform said printing.

14. The image formation apparatus according to claim 10, wherein
when said printing-prohibited state is canceled, said job execution management unit estimates printing completion estimate time at which printing of each of suspended print jobs is estimated to be completed, and
said printing necessity inquiring unit provides a transmitting source of each of the suspended print jobs with a notification of the printing completion estimate time for the print job.

15. A method for controlling an image formation apparatus disposed in a predetermined management range and provided to be capable of communicating with a power management apparatus configured to monitor a power usage amount in said predetermined management range, comprising:
receiving a print job;
receiving a printing prohibition command from said power management apparatus, said printing prohibition command indicating that the power usage amount in said predetermined management range is in a state in which printing by said image formation apparatus is to be prohibited;
setting a printing-prohibited state, in which the printing is prohibited in accordance with said printing prohibition command from said power management apparatus, and suspending execution of the print job received during said printing-prohibited state;
inquiring a transmitting source of the print job, which is suspended from being executed, as to whether to perform printing thereof after cancellation of said printing-prohibited state; and
executing at least one suspended print job after the cancellation of said printing-prohibited state, said at least one suspended print job having been confirmed such that printing thereof is necessary.
